(19) United States
(12) Patent Application Publication
(10) Pub. No.: US 2015/0207188 A1
(43) Pub. Date: Jul. 23, 2015

(54) BATTERY FOR VEHICLE

(71) Applicant: Hyundai Motor Company, Seoul (KR)

(72) Inventors: Jun Seok CHOI, Suwon-si (KR); Hae Kyu LIM, Bucheon-si (KR); Yoon Cheol JEON, Suwon-si (KR); Jeong Hun SEO, Suwon-si (KR); Yong Jin LEE, Yongin-si (KR)

(21) Appl. No.: 14/312,260

(22) Filed: Jun. 23, 2014

(30) Foreign Application Priority Data
Dec. 11, 2013 (KR) 10-2013-0154258

(51) Int. Cl. H01M 10/6551

(52) U.S. Cl. CPC H01M 10/6551; H01M 10/6552; H01M 10/6561; H01M 10/625; H01M 10/613; H01M 2220/20

(57) ABSTRACT

A battery for a vehicle includes a heat dissipating panel interposed between battery cells. A heat pipe is arranged in the heat dissipating panel and has an upper end portion serving as a contact portion, which extends to be exposed upward outside from an upper end of the battery cell and is bent inward to the upper end of the battery cell. A heat dissipating fin is in tight contact with the contact portion of the heat pipe.

### CROSS-REFERENCE TO RELATED APPLICATION

This application claims under 35 U.S.C. §119(a) the benefit of priority to Korean Patent Application No. 10-2013-0154258 filed Dec. 11, 2013, the entire contents of which are incorporated herein by reference.

### TECHNICAL FIELD

The present disclosure relates to a battery for a vehicle for use in a hybrid or electric vehicle, and more particularly to a battery for a vehicle which allows various forms of air-conditioning pipes to be used by employing an effective air-conditioning structure.

### BACKGROUND

In general, a high voltage battery for a vehicle needs to come with well-controlled air-conditioning because its performance and durability vary with temperature. Conventionally, battery cells in a conventional battery module are cooled indirectly to address the problem. However, since it is difficult to fix a heat pipe in such a conventional battery module, the heat pipe is likely to move as a vehicle moves in a vertical motion.

The conventional battery module has a heat sink structure extending in a longitudinal direction of a battery cell. Due to such structural constraints of the battery module, cooling is enabled only when a coolant channel extends in the longitudinal direction of the battery cell. That is, a battery pack to be mounted in the vehicle has a structural restriction.

Moreover, since the conventional battery module of an indirect air-cooling type or the conventional battery pack structure uses a typical heat dissipating panel such as an aluminum panel, it cannot guarantee sufficient cooling performance during heat emission from the battery cells.

The foregoing is intended merely to aid in the understanding of the background of the present disclosure, and is not intended to mean that the present disclosure falls within the purview of the related art that is already known to those skilled in the art.

### SUMMARY

The present disclosure has been made keeping in mind the above problems occurring in the related art, and the present disclosure is intended to propose a battery for a vehicle for use in a hybrid or electric vehicle. The battery allows various forms of air-conditioning pipes to be used by employing an effective air-conditioning structure.

According to an exemplary embodiment of the present disclosure, a battery for a vehicle includes a heat dissipating panel interposed between battery cells. A heat pipe is arranged in the heat dissipating panel and has an upper end portion serving as a contact portion which extends to be exposed outside from an upper end of the battery cell and is bent inward to the upper end of the battery cell. A heat dissipating fin is in tight contact with the contact portion of the heat pipe.

The heat pipe may be a plurality of heat pipes disposed in the heat panel and arranged at consistent intervals.

A length of the contact portion may be smaller than a width of the battery cell.

According to another exemplary embodiment of the disclosure, a battery for a vehicle includes a plurality of battery cells which are stacked on one another as a plate shape. A heat dissipating panel is interposed between the battery cells. A heat pipe is arranged in the heat dissipating panel and has an upper end portion serving as a contact portion which extends to be exposed outside from an upper end of a battery cell and is bent inward to the upper end of the battery cell. A heat dissipating fin is in tight contact with the contact portion of the heat pipe.

The contact portion may be a plurality of contact portions and the plurality of contact portions may be adjacent to each other as a planar surface, and the heat dissipating fin may be disposed to be in tight contact with the planar surface of the contact portions.

The heat pipe may be a plurality of heat pipes, and the plurality of heat pipes may be arranged at consistent intervals in a plurality of heat dissipating panels, respectively.

The plurality of heat dissipating fins may be installed at positions corresponding to the contact portions at upper ends of the battery cells, and a duct which covers the plurality of heat dissipating fins and has an air channel therein may be connected to the upper ends of the battery cells.

A height of the duct may be greater than that of the heat dissipating fin at an inlet portion and may decrease toward an outlet portion so that the duct has an inclined upper surface.

The height of the duct may be identical to that of the heat dissipating fin at the outlet portion.

The battery for a vehicle according to the present embodiment has the following advantages. It can be used for a hybrid or electric vehicle and allows various forms of air-conditioning pipes to be used by employing an effective air-conditioning structure.

Coolant channels can be orthogonal to each other or the coolant channels may be parallel to each other. Moreover, with use of the heat pipe, effective heat dissipation is enabled. Specifically, since the heat dissipating panel is in tight contact with two battery cells and is arranged between the two battery cells, a gap between the coolant channels is reduced compared to conventional structures, resulting in an increase in energy density.

Further, with use of the heat pipe, heat conductivity is maximized by phase change heat transfer. Accordingly, even with use of an indirect cooling scheme, sufficient cooling performance for the battery cells is secured. Since the upper portion of the heat pipe is bent and fixed, vertical fixing of the heat pipe is improved compared with the conventional structures.

Additionally, since the heat sink is provided as a separate component and is assembled with other parts after being prepared, coolant channels may be arranged to extend in various directions when the battery cells are packaged according to a direction in which the heat sink is coupled, and it is possible to reduce the number of heat sinks used for each battery module. This results in a reduction in weight of the battery.

### BRIEF DESCRIPTION OF THE DRAWINGS

The above and other objects, features and other advantages of the present disclosure will be more clearly understood from the following detailed description when taken in conjunction with the accompanying drawings.

FIG. 1 is a perspective view of a battery for a vehicle according to an exemplary embodiment of the present disclosure.

FIG. 2 is a view illustrating a heat dissipating panel for a battery for a vehicle according to an exemplary embodiment of the present disclosure.

FIG. 3 is a side elevation illustrating a battery for a vehicle according to an exemplary embodiment of the present disclosure.

FIGS. 4 and 5 are views illustrating high voltage batteries for a vehicle according to other embodiments of the present disclosure.

### DETAILED DESCRIPTION

Hereinbelow, exemplary embodiments of the present disclosure will be described in detail with reference to the accompanying drawings.

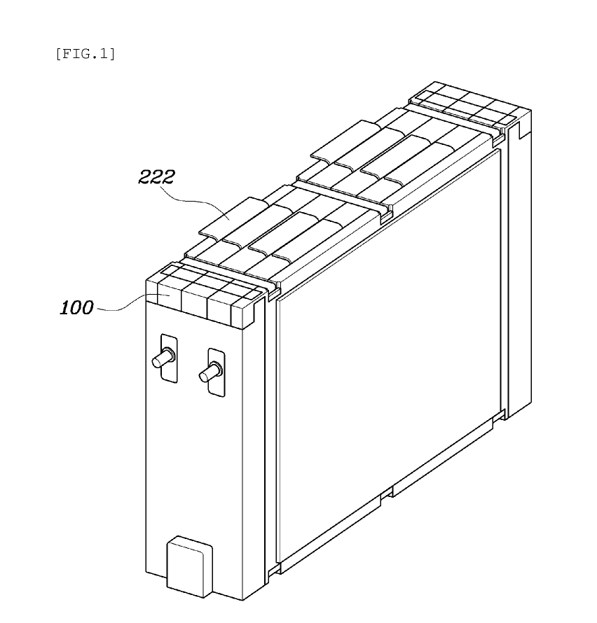

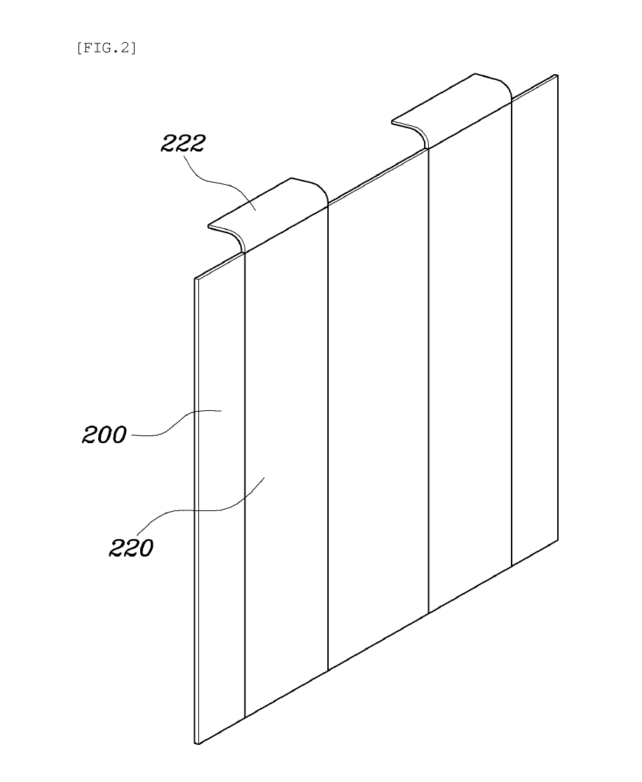

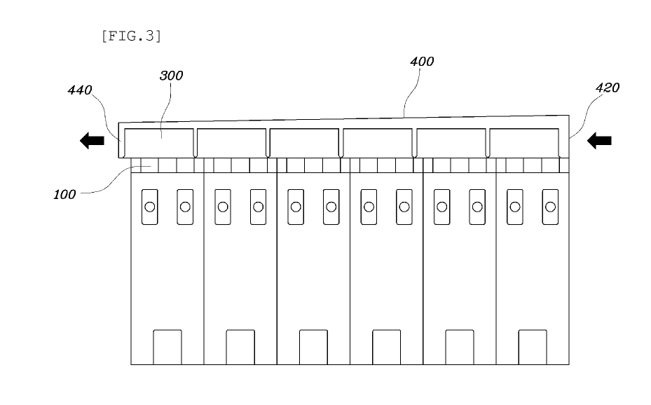

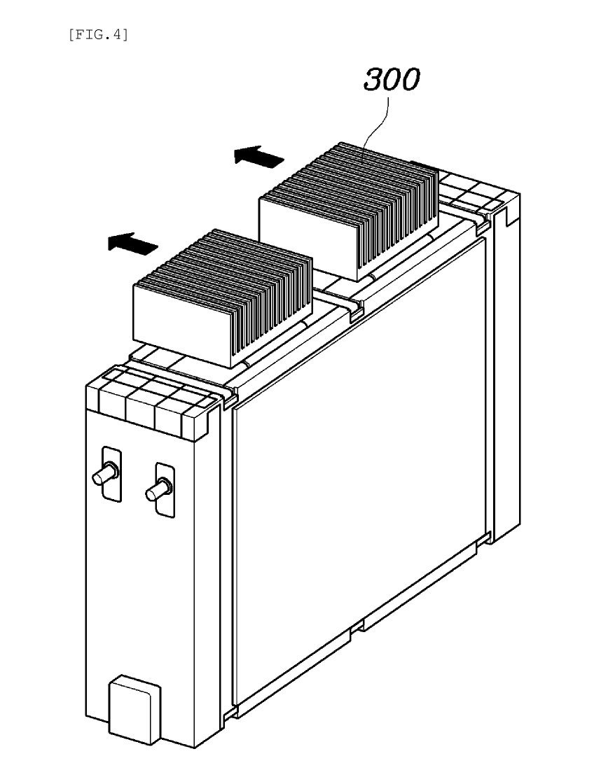

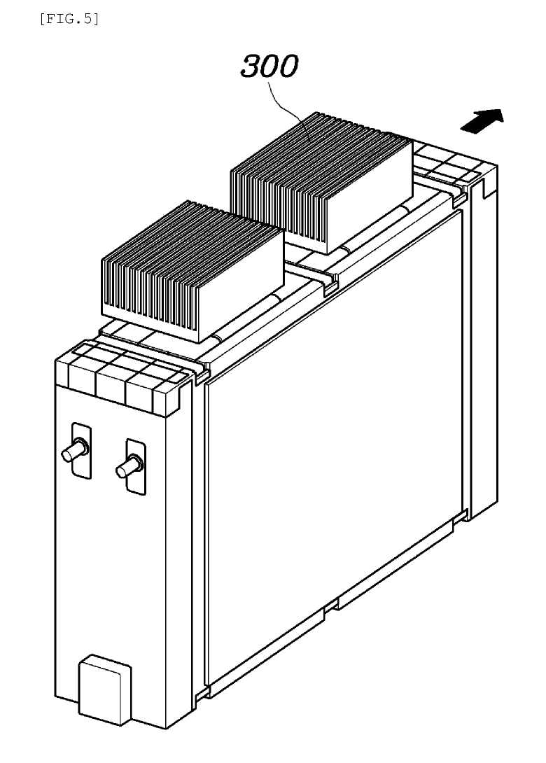

FIG. 1 is a perspective view of a battery for a vehicle according to an exemplary embodiment of the present disclosure, FIG. 2 is a view illustrating a heat dissipating panel for a battery for a vehicle according to an exemplary embodiment of the present disclosure, and FIG. 3 is a side elevation illustrating a battery for a vehicle according to an exemplary embodiment of the present disclosure FIGS. 4 and 5 are views illustrating high voltage batteries for a vehicle according to other exemplary embodiments of the present disclosure.

A battery for a vehicle according to an exemplary embodiment includes heat dissipating panels 200 each interposed between a plurality of battery cells 100, a plurality of heat pipes 220 arranged in the plurality of heat dissipating panels 200, and a plurality of heat dissipating fins 300. A base part of an upper end portion of each heat pipe 200 extends to be exposed outside from an upper end of a battery cell 100, and a distal part of the upper end portion is bent inward to the upper end of the battery cell 100. The upper end portion of the heat pipe 200 serves as a contact portion 222. A heat dissipating fin 300 is in tight contact with the contact portion 222.

Specifically, in the battery for a vehicle according to the present disclosure, the plurality of battery cells 100 are stacked to be formed as a plate shape, and each of the heat dissipating panels 200 is interposed between two battery cells adjacent to each other. With this structure, the temperature of the heat dissipating panels 200 is indirectly controlled, ultimately controlling the temperature of the battery for a vehicle.

The heat dissipating panels 200 are interposed between the battery cells 100. The heat dissipating panels 200 are made of plastic and are produced through insert injection molding through which the heat pipes 220 are embedded in the heat dissipating panels 200.

The heat pipes 220 are disposed in the heat dissipating panels 200. The heat pipes 220 are heat transfer members which use the latent heat of vapor to transfer heat at supersonic speed. When a heat dissipating part is disposed at an upper end in a battery, heat transfer efficiency is the highest. Accordingly, the upper end portions of the heat pipes 220 are arranged to extend upward from the upper ends of the battery cells 100 and are bent inward to the upper ends of the battery cells 100. The upper end portions of the heat pipes 220 serve as the contact portions 222. The heat dissipating fins 300 may be installed to be in tight contact with a planar upper surface of the contact portions 222.

FIG. 2 illustrates the heat pipe 220 and the heat dissipating panel 200. The heat dissipating panel 200 is prepared by insert injection molding, so that the heat pipe 220 is embedded in the heat dissipating panel 200. The heat pipe 220 may be a plurality of heat pipes, and the plurality of heat pipes 220 may be arranged at consistent intervals.

The contact portion 222 is bent at an upper portion thereof, and the heat dissipating fin 300 is fixed to the contact portion 222. A length of the contact portion 222 is smaller than a width of the battery cell 100, and the contact portion 222 has a planar upper surface. The contact portion 220 may a plurality of contact portions, and the plurality of contact portions 222 are arranged not to interfere with each other.

Alternatively, a battery for a vehicle according to another embodiment of the present disclosure includes a plurality of battery cells 100 stacked on one another to form a plate shape. Heat dissipating panels 200 are each arranged between the battery cells 100. Heat pipes 220 are each arranged in the heat dissipating panel 200 and have an upper end portion serving as contact portions 222 which extends to be exposed upward outside from an upper end of the heat pipe 220 and is bent inward to an upper end of battery cells 100. Heat dissipating fins 300 are in tight contact with contact portions 222 of the heat pipes 220.

As illustrated in FIG. 1, the contact portions 222 are near upper end surfaces of the plurality of battery cells 100 and form a planar surface, and the heat dissipating fins 300 may be installed to be in tight contact with the planar surface. The heat pipes 220 may be installed to correspond to the heat dissipating panels 200, respectively and arranged at consistent intervals.

As illustrated in FIGS. 4 and 5, the heat dissipating fins 300 are arranged at upper ends of the plurality of battery cells 100 and at positions corresponding to the contact portions 222. A duct 400 serves as an air channel and is connected to the upper ends of the battery cells 100. The duct 400 is arranged to cover the plurality of heat dissipating fins 300.

With reference to FIG. 4, the duct 400 has an inlet having a height which is greater than that of the heat dissipating fin 300. The height of the duct 400 decreases toward an outlet 440 of the duct 400. That is, the upper surface of the duct 400 is an inclined surface. This structure increases heat dissipation efficiency. Moreover, since wind passes between the inlet 420 and the heat dissipating fin 300 and directly travels to the outlet 440, heat dissipating performance may be uniform over the entire length of the duct 400. The height of the duct 400 at the outlet 400 may be identical to that of the heat dissipating fin 300.

The high voltage batteries for a vehicle according to the embodiments which are illustrated in FIGS. 4 to 5 have the following advantages. They can be used for a hybrid or electric vehicle and have an effective air-conditioning structure.

Air-conditioning air channels may be orthogonal to each other, or the air-conditioning air channels may be parallel to each other. In addition, with use of the heat pipes, effective heat dissipation can be achieved. In addition, since the heat dissipating panel is in tight contact with and is arranged between two battery cells, the space of air channels is reduced compared with conventional structures, resulting in an increase in bulk energy density.

Furthermore, with use of the heat pipe, heat conductivity is maximized by phase change heat transfer. Accordingly, even with use of an indirect cooling scheme, sufficient cooling performance for battery cells is secured. Since the upper portion of the heat pipe is bent and fixed, vertical fixing of the heat pipe is improved compared with conventional structures.

Additionally, since a heat sink is provided as a separate component and is assembled with other parts later, coolant channels may be arranged in various directions when the battery cells are packaged according to a direction in which the heat sink is coupled, and it is possible to reduce the number of the heat sinks for each battery module. This results in a decrease in weight.

Although a preferred embodiment of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. A battery for a vehicle, comprising:
a heat dissipating panel interposed between battery cells;
a heat pipe arranged in the heat dissipating panel and provided with an upper portion serving as a contact portion which extends to be exposed outside from an upper end of a battery cell and which is bent inward to the upper end of the battery cell; and
a heat dissipating fin that is in tight contact with the contact portion of the heat pipe.

2. The battery for a vehicle according to claim 1, wherein the heat pipe is a plurality of heat pipes and the plurality of heat pipes are arranged at consistent intervals and disposed in a plurality of heat dissipating panels, respectively.

3. The battery for a vehicle according to claim 1, wherein a length of the contact portion is smaller than a width of the battery cell.

4. A battery for a vehicle, comprising:
a plurality of battery cells stacked as a plate shape;
a plate-shaped heat dissipating panel arranged between the plurality of battery cells;
a heat pipe arranged in the heat dissipating panel and provided with an upper portion thereof serving as a contact portion which extends to be exposed outside from an upper end of a battery cell and which is bent inward to the upper end of the battery cell; and
a heat dissipating fin that is in tight contact with the contact portion of the heat pipe.

5. The battery for a vehicle according to claim 4, wherein a plurality of contact portions adjacent to each other as a planar surface in a position near upper ends of the plurality of battery cells, and a plurality heat dissipating fins are in tight contact with the planar surface.

6. The battery for a vehicle according to claim 4, wherein the heat pipe is a plurality of heat pipes, and the plurality of heat pipes are arranged at consistent intervals in a plurality of heat dissipating panels, respectively.

7. The battery for a vehicle according to claim 6, wherein the plurality of heat dissipating fins are arranged at the upper ends of the plurality of battery cells and at positions corresponding to the contact portions, and a duct that covers the heat dissipating fins and has an air channel is connected to the upper ends of the battery cells.

8. The battery for a vehicle according to claim 7, wherein the duct has a height which is higher than that of the heat dissipating fin at an inlet and gradually decreases toward an outlet so that the duct is inclined down from the inlet to the outlet.

9. The battery for a vehicle according to claim 8, wherein the height of the duct at the outlet is identical to that of the heat dissipating fin.

10. The battery for a vehicle according to claim 1, wherein the heat dissipating panel is made of plastic and is prepared through insert injection molding so that the heat pipe is embedded in the heat dissipating panel.
